(19) United States
(12) Patent Application Publication
(10) Pub. No.: US 2010/0252574 A1
(43) Pub. Date: Oct. 7, 2010

(54) DISPENSER DEVICE FOR BI-COMPONENT SUBSTANCES

(75) Inventor: Tiziano Busin, Rovigo (IT)

Correspondence Address: Pearne & Gordon LLP, 1801 East 9th Street, Suite 1200, Cleveland, OH, 44114-3108, US

(73) Assignee: ZHERMACK S.P.A., 45021 Badia Polesine (RO) (IT)

(21) Appl. No.: 12/742,202

(22) PCT Filed: Nov. 12, 2007
(86) PCT No.: PCT/IT2007/000796

§ 371 Date: May 10, 2010

(51) Int. Cl. B67D 7/74; B05C 17/005

(52) U.S. Cl. 222/137; 222/145.6; 222/333

(57) ABSTRACT

A dispenser device for bi-component substances comprises a support structure (2); a receiving seat (5) formed inside said support structure (2) and in which at least two cartridges (6) can be housed for containing each a respective component of a substance to be mixed, as well as a mixer (7) in fluid communication with said cartridges (6) to mix said components; an ejection member (12) acting on the cartridges. (6) to enable dispensing of said components; the dispenser device further comprises coupling means (25) disposed on the support structure (2) to allow the dispenser device to be steadily coupled with another dispenser device.

The present invention relates to a dispenser device for bi-component substances. In particular, the present invention applies to odontology, for preparing and dispensing materials for dental impressions, silicones or others, formed with two distinct components.

In more detail, these substances are made up of a cross-linkable material and a cross-linking agent that must remain separated before use. Mixing of the two components gives rise to cross-linking of the mixed material within a predetermined period of time. The components therefore must be mixed together just before use.

The dispenser devices for bi-component substances of known type comprise a supporting body in which a receiving seat for a cartridge containing the two components of the substance to be mixed is formed.

These dispenser devices also comprise means designed to cause discharge of the components from the cartridge into a mixer the task of which is to mix the two components so as to generate a homogeneous composition. This means generally consists of a piston acting on a moving wall of the cartridge in order to reduce volume of same and cause dispensing of the substance.

Mixers are of the disposable type and can be static or dynamic. Static mixers comprise a dispensing nozzle and a fixed mixing element which is suitably shaped so as to promote mixing of the components. Dynamic mixers on the contrary comprise a propeller contained in the dispensing nozzle and set in rotation by a respective motor.

It is to be noted that the dispenser devices for bi-component substances are such conceived as to hold only one pair of components each time, to dispense the desired material for dental impressions, for example. However, frequently two different mixed bi-component substances are to be used during a single dental treatment session.

For instance, for obtaining a dental impression it is sometimes necessary to use a high viscosity material (termed tray material) together with a low viscosity material (termed lowering material).

In this case, the operator must be able to replace one cartridge with another in a very quick manner and in any case before the cross-linking reaction of the first-dispensed substance may occur.

Since this operation is very uncomfortable and delicate, in dentists' surgeries there is often the presence of two or more identical dispenser devices each designed to a different bi-component substance.

Disadvantageously, availability of a plurality of distinct dispenser devices involves great bulkiness. In addition, use of distinct dispenser devices is expensive and unpractical.

Within this context, the technical task of the present invention is to propose a dispenser device for bi-component substances that is without the mentioned drawbacks.

In particular, the present invention aims at proposing a dispenser device for bi-component substances having reduced bulkiness and increased compactness.

In addition, the invention aims at proposing a dispenser device that can be easily transported and controlled in a simple manner.

It is a further aim of the invention to propose a dispenser device for bi-component substances with an improved aesthetic appearance and adapted to be personalised.

In accordance with the present invention, the technical task and the aims herein described are achieved by a dispenser device for bi-component substances comprising the technical features set out in one or more of the appended claims.

Further features and advantages of the present invention will become more apparent from the detailed description of a preferred but not exclusive embodiment of a dispenser device for bi-component substances given by way of non-limiting example, as illustrated in the accompanying drawings, in which:

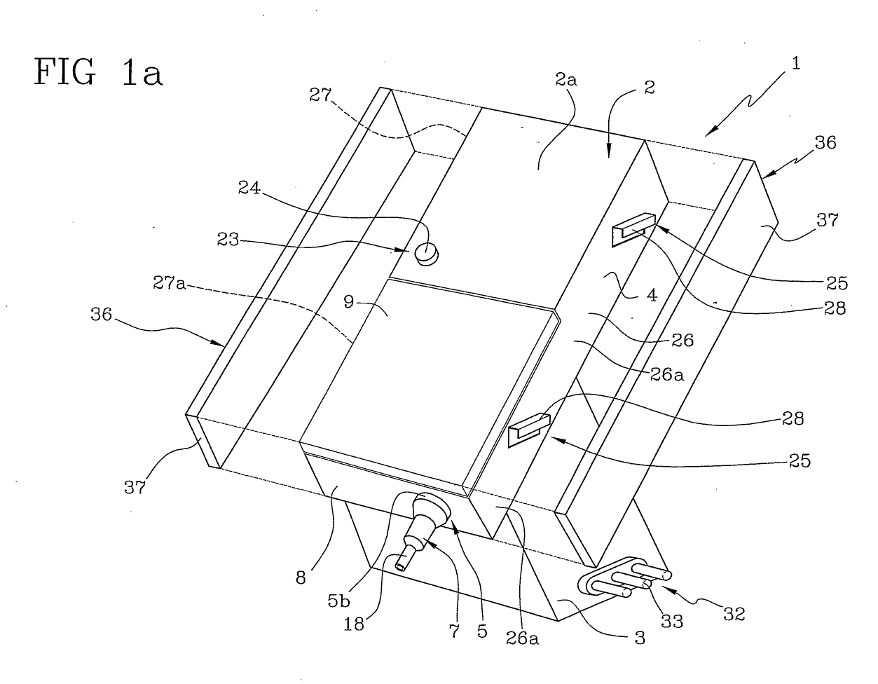

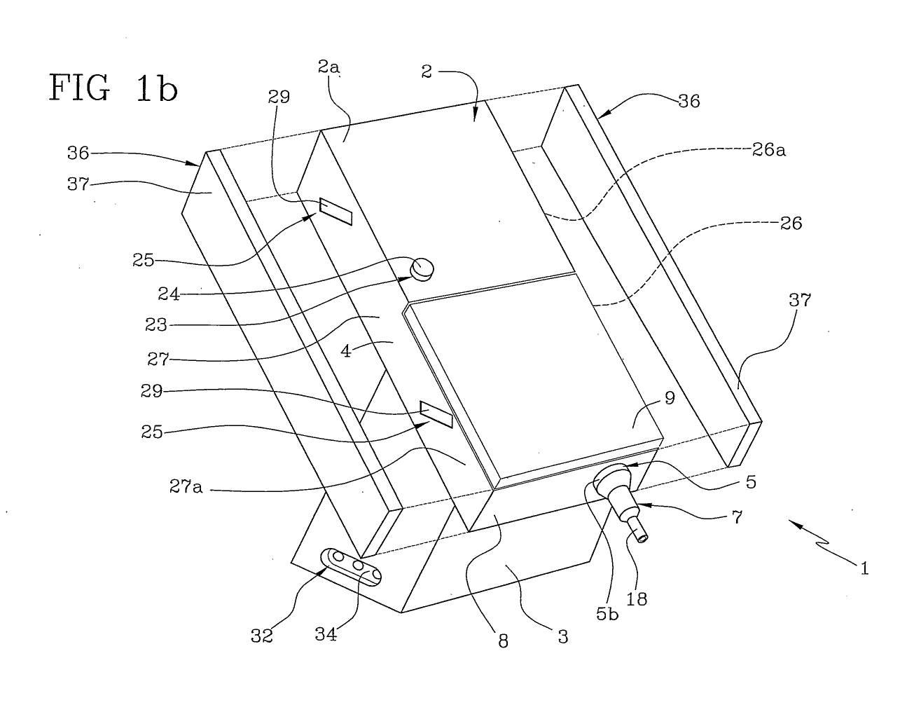

FIGS. 1a and 1b show respective perspective views of a first embodiment of a dispenser device for bi-component substances according to the present invention;

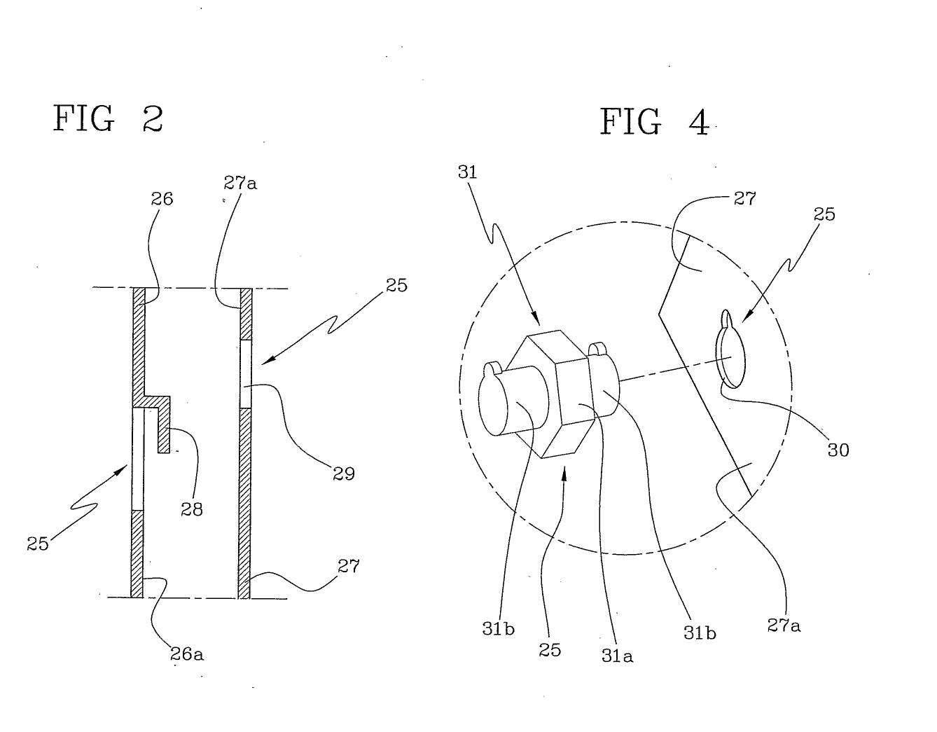

FIG. 2 is a section view of a detail of the dispenser device seen in FIGS. 1a and 1b;

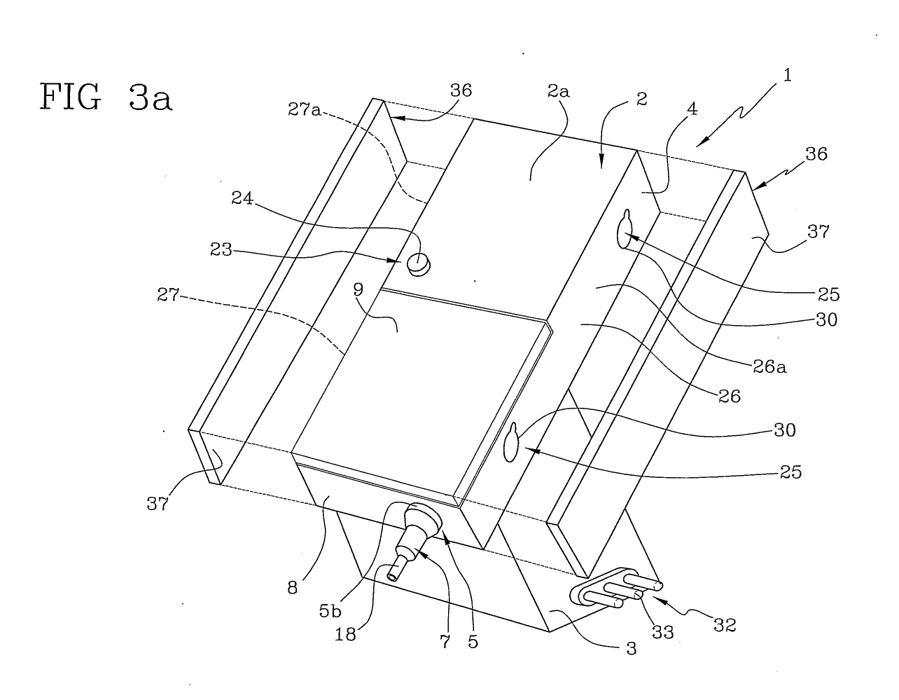

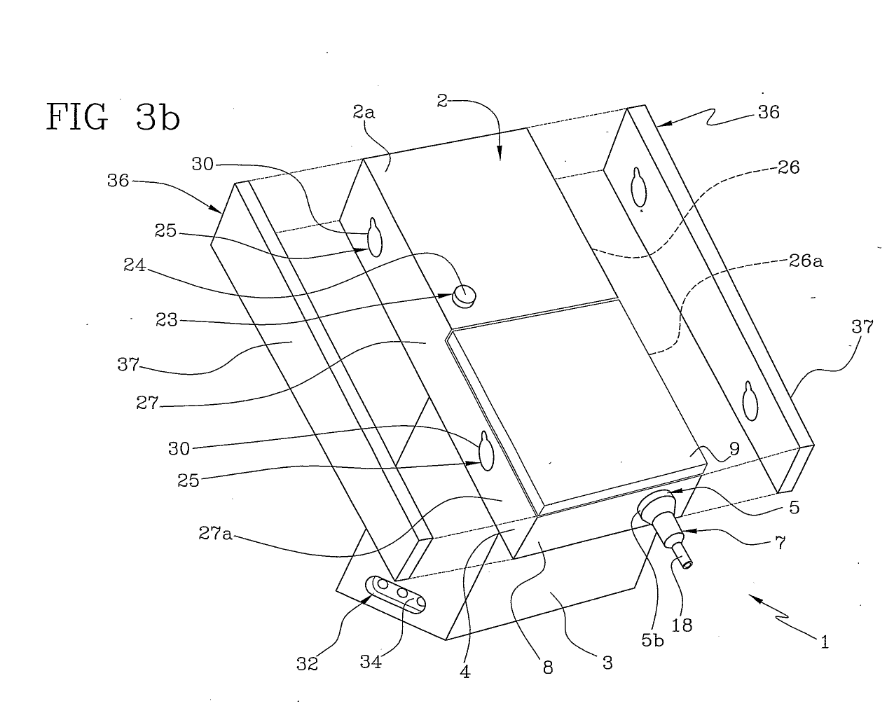

FIGS. 3a and 3b show respective perspective views of a second embodiment of the dispenser device for bi-component substances according to the present invention;

FIG. 4 shows a perspective view of a detail of the dispenser device seen in FIGS. 3a and 3b;

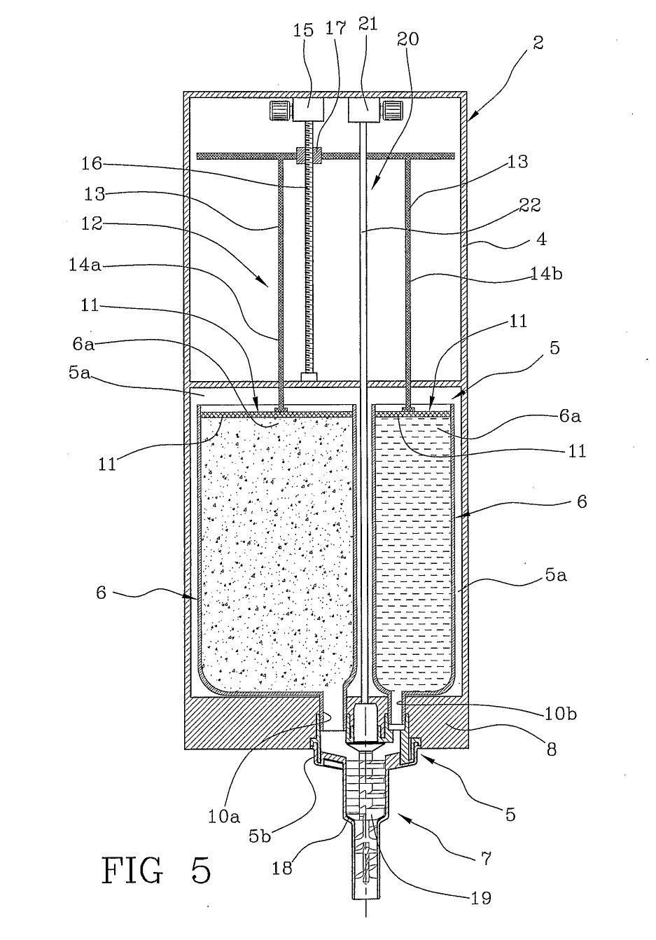

FIG. 5 shows a section view of the dispenser device according to the present invention;

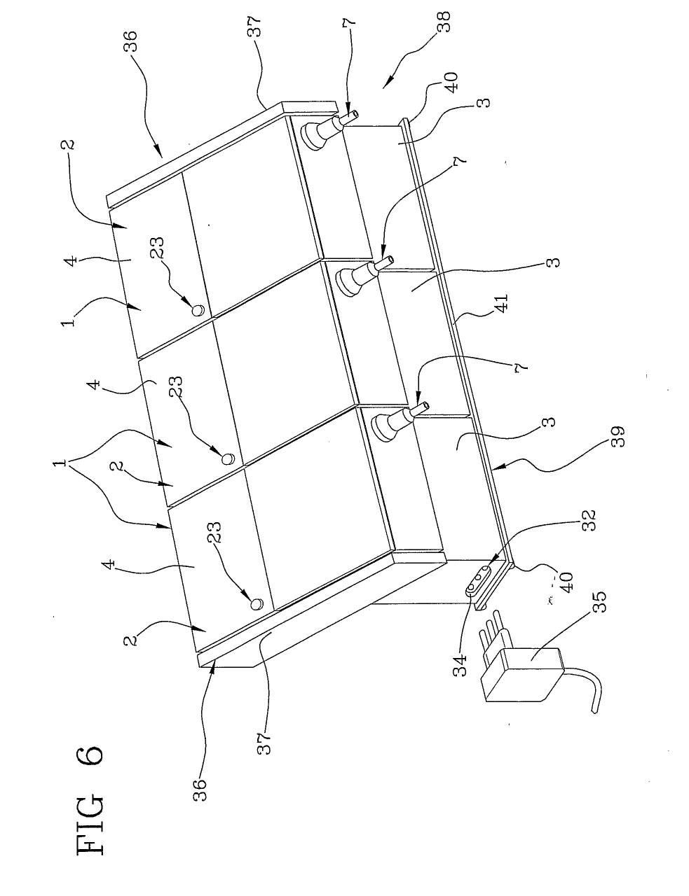

FIG. 6 is a perspective view of a set of dispenser devices for bi-component substances according to the present invention.

With reference to the drawings, a dispenser device for bi-component substances in accordance with the present invention has been generally identified with reference numeral 1.

The dispenser device 1 comprises a supporting structure 2 having a base 3 and a holding body 4 fastened to the base and disposed with its major extension axis inclined to a horizontal reference.

Formed in the supporting structure 2 is a receiving seat 5 to house at least two cartridges 6 containing respective components of said substance and a mixer 7 adapted to homogeneously mix and amalgamate the two components. Cartridges 6 can be separated and distinct or, alternatively, can be of one piece construction with a single supporting structure.

In detail, a first portion 5a of the receiving seat 5 is formed in the holding body 4 to receive cartridges 6 and a second portion 5b of the receiving seat 5 is formed in a lower wall 8 of the supporting structure 2 to receive mixer 7.

The dispenser device 1 comprises a door or hatch 9 disposed in an upper surface 2a of the supporting structure 2. This hatch 9 allows access to the first portion 5a of the receiving seat 5 for introducing or removing cartridges 6.

Cartridges 6 are in fluid communication with mixer 7 to enable the components to be transferred thereinto. In detail, formed in the lower wall 8 of the supporting structure 2 are ducts 10a, 10b enabling passage of each component from the respective cartridge 6 to mixer 7.

Cartridges 6 further, have a respective movable piston 11 disposed in the vicinity of the respective end 6a of each distal cartridge 6 relative to mixer 7. Pistons 11 are movable close to mixer 7 to force the components into the mixer 7 itself.

To this aim, the dispenser device 1 comprises an ejection member 12 acting on cartridges 6 (FIG. 5). In detail, the ejection member 12 comprises a pusher 13 put into contact with pistons 11 to force the pistons 11 themselves forward.

In the described embodiment, pusher 13 comprises two rods 14a, 14b each in contact with a respective piston 11.

The ejection member 12 further comprises a motor 15 to drive pusher 13 and therefore pistons 11 in motion. By way of example, coupling between motor 15 and pusher 13 is made through a worm screw 16 and a lead nut associated with rods the 14a, 14b.

Mixer 17 associable with the dispenser device 1 is of the disposable type. In fact, once dispensing of the substance has been carried out, a portion of the already mixed substance intended for cross-linking remains inside mixer 7. The subsequent substance dispensing can only take place by replacing mixer 7.

In the described embodiment, mixer 7 is of the combined dynamic-static type and comprises a dispensing nozzle 8 to be coupled with the dispenser device 1 at the second portion 5b of the receiving seat 5.

Coaxially disposed at the inside of nozzle 8 is a propeller 19 that, suitably set in rotation, promotes mixing of the components.

In detail, the dispenser device 1 comprises actuating means 20 for movement of propeller 19, which means comprises a motor 21, a possible reduction gear (not Shown in the figures) and a shaft 22 to be fitted into propeller 19 to drive it in rotation.

Shaft 22 has a shaped cross section to form an integrally-rotating coupling between shaft 22 and propeller 19. By way of example, shaft 22 has a hexagonal cross section.

The dispenser device 1 further comprises drive means 23 associated with the ejection member 12 to operate dispensing of the substance. In particular, the drive means 23 acts on motor 15 of the ejection member 12 to actuate pusher 13. Said drive means 23 also acts on motor 21 of the actuating means 20 of mixer 7 to move propeller 19.

Preferably, operation of motor 15 of the ejection member 12 is simultaneous with operation of motor 21 of the actuating means 20 of mixer 7.

The drive means 23 comprises a button 24 advantageously disposed on the upper surface 2a of the supporting structure 2. In more detail, the dispenser device is such designed as to be of the modular type, i.e. dispenser 1 can be associated with a desired number of further identical dispensers without particular interventions or modifications of the supporting structure 2a being required.

For the above purpose, the dispenser device 1 comprises coupling means 25 disposed on the supporting structure 2 to enable steady coupling of the dispenser device 1 with a further dispensing device.

The supporting structure 2 comprises a first 26 and a second 27 side wall facing each other. In detail, the coupling means 25 is disposed on the first 26 and second 27 side walls in such a manner that the first 26 or second 27 side wall of the dispenser device 1 will be associable with the corresponding second 27 or first 26 side wall of a further adjacent dispenser device.

To this aim, it will be recognised that the first 26 and second 27 side walls have respective outer surfaces 26a, 27a mutually conforming in shape, so that the dispenser device 1 can be easily associated with another dispenser device disposed in side by side relationship therewith.

It will be appreciated that advantageously the dispenser device 1 has no manual-access commands disposed on the first 26 and/or second side walls 27. Consequently, the dispenser device 1 can be associated with another dispenser device by placing the first 26 and second 27 side walls in side by side relationship. Therefore it is not possible to place commands at the side walls 26, 27 because an approached arrangement of the dispenser devices precludes lateral access to the devices themselves.

In this regard, all commands, transmissions for operation are inside, or on the upper part of, the device so that they do not interfere when several devices are to be coupled in a modular manner.

In a first embodiment, the coupling means 25 comprises at least one hook 28 disposed on the first 26 or second 27 side wall and a corresponding slot 29 disposed on the second 27 or first side wall 26 at a position in register with hook 28.

In the embodiment shown in FIGS. 1a and 1b, the dispenser device 1 comprises two hooks 28 formed on the first side wall 26 and two corresponding slots 29 disposed on the second side wall 27.

Preferably, hooks 28 and slots 29 are formed integrally with the first 26 and second 27 side walls, in known manner. For instance, hooks 28 and slots 29 can be made by a bending and/or punching operation.

With reference to FIG. 3, in a coupled configuration each hook 28 houses in the respective slot 29.

In a second embodiment, the first 28 and second 29 side walls have respective openings in mutual alignment. In this case, the coupling means 25 comprises a hooking element 31 to be engaged in the respective openings 30 in the first 26 and second 27 side walls.

In detail, this hooking element 31 is insertable in the opening 30 formed in the first side wall 26 of the dispenser device 1 and in the opening 30 formed in the second side wall 27 of another dispenser device.

In the embodiment shown in FIGS. 3a and 3b, the dispenser device 1 comprises two openings 30 formed in each first 26 and second 27 side wall in such a manner as to be aligned two by two.

With particular reference to FIG. 4, the hooking element 31 comprises a central portion 31a adapted to be engaged by a tool to move the hooking element 28 during a step of associating the dispenser device 1 with another dispenser device 1, and two end portions 31b insertable into openings 30.

In particular, openings 30 in a first configuration enable entry of the end portions 31b into the supporting structure 2 and in a second configuration prevent exit of the end portions 31b, so that the dispenser device 1 can be maintained steadily associated with another dispenser device disposed in side by side relationship therewith. In other words, the shape of the end portions 31b matches the shape of openings 30 into which the former must be introduced.

It will be understood that the adopted embodiment for the hooking means is not essential and therefore it can be different from that shown, provided the set does not lose its modular character, i.e. provided engagement of any number of identical dispenser devices is allowed.

The dispenser device 1 can further comprise means 32 for electric connection to allow electrical connection of the dispenser device 1 with another dispenser device associated therewith.

In detail, the electric-connection means 32 comprises a male connector 33 disposed on the first side wall 26 for example, and a female connector 34 placed on the second side wall 27.

In this manner, as better clarified in the following, it will be possible to associate two or more dispenser devices 1 by disposing them in mutual side by side relationship and powering them with only one external power supply 35.

The dispenser device 1 further comprises a lateral finish body 36 that can be placed over the coupling means 25 to conceal it. In particular, this lateral finish body 36 is adapted to cover the coupling means that is not used and that therefore would be in sight, when a dispenser device 1 is associated with another dispensing device.

In detail, the lateral finish body 36 comprises panels 37 adapted to be superposed on the first 26 and/or the second side wall 27; these panels possibly can be painted or at all events personalised to give the dispenser the desired aesthetic appearance. In other words, each module will be provided with the respective self-supporting structure 2, while the lateral finish bodies 36 or aesthetic shells will have to be alternatively applied to the sides of a single dispenser or the sides of several coupled dispensers forming the module.

The invention can further form a set 38 comprising a predetermined number of the above described dispenser devices 1 (FIG. 6).

In particular, the dispenser devices 1 are disposed side by side in such a manner that the first side wall 26 of a dispenser 1 is coupled with the second side wall 27 of an adjacent dispenser 1 through the described coupling means 25.

Set 38 further comprises a support 39 to bear the plurality of dispenser devices 1 associated with each other. In particular, by way of example, support 39 can comprise a plurality of feet 40 mutually connected by a suitable frame 41 on which the plurality of dispenser devices 1 rests.

In an alternative embodiment, support 39 comprises a hook (not shown in the figures) to hang the set 38 of dispensers on a wall.

As mentioned above, set 38 further comprises said power supply 35 to electrically feed the dispenser devices 1.

It will be appreciated that for set 38 only one power supply 35 is required which is connected to one alone of said dispenser devices 1. In fact, all dispenser devices 1 are electrically connected by the above mentioned electric-connection means 32.

In addition, set 38 comprises said lateral finish body covering the unused coupling means 25. In particular, the lateral finish body 36 comprises panels 37 adapted to be superposed on the second wall 27 of the first dispenser device 1 and the first side wall 26 of the last dispenser device 1.

The invention reaches the intended purposes and achieves important advantages.

First of all, it is possible to steadily associate a predetermined number of dispenser devices 1 in such a manner that each lies side by side with, and connected to the adjacent one.

This allows an important space to be saved and more comfort to be reached because the dispenser devices 1 constitute a single body easily movable depending on requirements.

It is also to be pointed out that the presence of the electric-connection means 32 enables use of a single power supply 35 capable of feeding all the dispenser devices 1 associated with each other with electric energy. This too allows simpler use and space economy.

In addition, the lateral finish body 36 allows the unused coupling means 25 to be covered thus achieving an improved aesthetic effect. It is also possible to provide a plurality of lateral finish bodies 36 differently decorated to adapt them to the harmony of the room where the dispenser device 1 or set 38 are to be used.

In case of damage of one of said finish bodies, the same can be replaced in a very simple manner and with very low costs.

In addition, the system is very versatile because if only one device is first purchased, other devices can be added also later on, depending on requirements.

1. A dispenser device for bi-component substances comprising:
a supporting structure (2);
a receiving seat (5) formed inside said supporting structure (2) and in which at least two cartridges (6) can be housed, each of them containing one respective component of a substance to be mixed, as well as a mixer (7) in fluid communication with said cartridges (6), in order to mix said components;
an ejection member (12) capable of acting on both the cartridges (6) to enable dispensing of said components; said dispenser device being characterised in that it is a modular type dispenser device further comprising coupling means (25) disposed on said supporting structure (2) to allow steady coupling of said dispenser device with another dispenser device.

2. A dispenser device as claimed in claim 1, characterised in that said supporting structure (2) is provided with a first (26) and a second (27) side wall which are substantially opposite to each other; said coupling means (25) being associated with said first (26) and/or second (27) side walls of said supporting structure (2) to steadily couple said first (26) or second (27) side wall of said dispenser device with said second (27) or first (26) side wall of another dispenser device.

3. A dispenser device as claimed in claim 2, characterised in that said first (26) and second (27) side walls have substantially matching respective outer surfaces (26a, 27a).

4. A dispenser device as claimed in claim 2, characterised in that said first (26) and second (27) side walls are without manual-access command members.

5. A dispenser device as claimed in claim 2, characterised in that it further comprises a lateral finish body (36) that can be superposed on said coupling means (25) and preferably on said first (26) and second (27) side walls to conceal the latter.

6. A dispenser device as claimed in claim 5, characterised in that said covering body (36) comprises at least one panel (37) adapted to be superposed on said first (26) and/or second (27) side wall.

7. A dispenser device as claimed in claim 1, characterised in that the ejection member (12) comprises at least one pusher (13) acting on respective pistons (11) of said cartridges (6) to force said pistons (11) forward and cause discharge of said components from said cartridges.

8. A dispenser device as claimed in claim 1, characterised in that it further comprises drive means (23) acting on said ejection member (12) to cause dispensing of said components; said drive means (23) being disposed on an upper surface (2a) of said supporting structure (2).

9. A dispenser device as claimed in claim 1, characterised in that it further comprises actuating means (20) to drive a propeller (19) of said mixer (7); said actuating means (20) comprising a motor (21) and a shaft (22) adapted to be fitted into the propeller (19) to set it in rotation.

10. A dispenser device as claimed in claim 9, characterised in that said shaft (22) has a shaped cross-section to create a steady coupling between said shaft (22) and propeller (19).

11. A dispenser device as claimed in claim 2, characterised in that the coupling means (25) comprises at least one hook (28) associated with said first side wall (26) and a slot (29) made on said second side wall (27) at a position corresponding to said hook (28); said slot (29) being adapted to receive said hook (28) of another dispenser device.

12. A dispenser device as claimed in claim 11, characterised in that said hook (28) and slot (29) are made integrally with said first (26) and second (27) side walls by a bending and/or punching operation.

13. A dispenser device as claimed in claim 11, characterised in that it comprises a plurality of said hooks (28) and a corresponding plurality of said slots (29).

14. A dispenser device as claimed in claim 2, characterised in that said first (26) and second (27) side walls have respective openings (30) preferably aligned with each other; said coupling means (25) comprising at least one hooking element (31) intended for engagement in said opening (31) of said first side wall (26) and in said opening (30) of said second wall (27) of another dispenser device.

15. A dispenser device as claimed in claim 14, characterised in that said hooking element (31) comprises a central portion (31a) and two shaped end portions (31b) adapted to be inserted into said openings (30) to keep said dispenser device associated with another dispenser device.

16. A dispenser device as claimed in claim 15, characterised in that said openings (30) in a first operating configuration enable access of said shaped end portions (31b) to the inside of said supporting structure (2) and in a second operating configuration prevent exit of said end portions (31b).

17. A dispenser device as claimed in claim 2, characterised in that it further comprises electric-connection means (32) to electrically connect said dispenser device to another dispenser device.

18. A dispenser device as claimed in claim 17, characterised in that said connection means (32) comprises a male connector (33) disposed on said first side wall (26) and a female connector (34) disposed on said second side wall (27) whereby it will be possible to associate two or more dispenser devices (1) by disposing them in mutual side by side relationship and powering them with only one external power supply (35).

19. A set comprising a predetermined number of dispenser devices, each comprising:
a supporting structure (2);
a receiving seat (5) formed inside said supporting structure (2) and in which at least two cartridges (6) can be housed, each of them containing one respective component of a substance to be mixed as well as a mixer (7) in fluid communication with said cartridges (6) in order to mix said components;
an ejection member (12) capable of acting on both the cartridges (6) to enable dispensing of said components; said set being characterised in that each dispenser device in the set is a modular type dispenser device steadily coupled with another dispenser device of the set through coupling means (25) associated with each supporting structure (2).

20. A set as claimed in claim 19, characterised in that each supporting structure (2) comprises a first (26) and a second (27) side wall facing each other; each first wall (26) of a dispenser device being associated with each second wall (27) of a subsequent dispenser device.

21. A set as claimed in claim 19, characterised in that it comprises a single support (39) to bear said dispenser devices.

22. A set as claimed in claim 21, characterised in that said support (39) comprises a plurality of support feet (40).

23. A set as claimed in claim 21, characterised in that said support (39) comprises a hook to fix said set to a wall.

24. A set as claimed in claim 19, characterised in that each dispenser device comprises electric-connection means (32) to connect each dispenser device to an adjacent dispenser device and only one external power supply (35) whereby it will be possible to associate two or more dispenser devices (1) by disposing them in mutual side by side relationship and powering them with the only one external supply (35).

25. A set as claimed in claim 24, characterised in that said connection means (32) of each dispenser device comprises a male connector (33) disposed on said first side wall (26) and a female connector (34) disposed on said second side wall (27), the male connector (33) of a dispenser device being suitable for being associated to a female connector of an adjacent dispenser device and the female connector (34) of a dispenser device being suitable for being associated to a male connector of an adjacent dispenser device, and said power supply (35) electrically feeding all the dispenser devices of the set.

26. A set as claimed in claim 19, characterised in that it further comprises a lateral finish body (36) associated with a first one and a last one of said dispenser devices and adapted to be superposed on said coupling means (25).

27. A set as claimed in claim 26, characterised in that said lateral finish body (36) comprises panels (37) adapted to be superposed on said second side wall (27) of said first dispenser device and on said first side wall (26) of said last dispenser device.
